(19) United States
(12) Patent Application Publication
(10) Pub. No.: US 2016/0061576 A1
(43) Pub. Date: Mar. 3, 2016

(54) Two Plane Protractor and Display Device

(71) Applicant: Barry Douglas Wixey, Sanibel, FL (US)

(72) Inventor: Barry Douglas Wixey, Sanibel, FL (US)

(21) Appl. No.: 14/837,469

(22) Filed: Aug. 27, 2015

Related U.S. Application Data
(60) Provisional application No. 62/070,503, filed on Aug. 27, 2014.

(51) Int. Cl. G01B 3/56; G01B 5/24

(52) U.S. Cl. CPC G01B 3/563; G01B 5/24

(57) ABSTRACT

A two plane protractor for installing adjoining pieces of molding and trim includes a first pair of wall angle measurement arms interconnected to one another through a gear assembly that allows the wall angle measurement arms to be angularly adjusted in unison relative to one another in a first degree of freedom. A pair of spring angle measurement arms are attached respectively to the wall angle measurement arms for rotating in a second degree of freedom about respective longitudinal axes of the wall angle measurement arms. A first sensor measures angular displacement between the first and second wall angle measurement arms and a second sensor measures rotational tilt of at least one spring angle measurement arm. A microprocessor calculates bevel and miter angles based upon the measured wall and spring angles. An electronic display digitally indicates calculated bevel and miter angles and graphically depicts icons simulating trim pieces and suggested placement on a compound miter saw for cutting the calculated bevel and miter angles.

### RELATED APPPLICATION

This application claims the benefit of U.S. Provisional Patent Application No. 62/070,503 filed Aug. 27, 2014.

### FIELD OF THE INVENTION

This invention relates to a two plane protractor and display device and, more particularly, to a device intended primarily for use in determining and displaying miter and bevel angles needed to install adjoining pieces of molding and trim in crown molding and similar applications.

### BACKGROUND OF THE INVENTION

Crown molding and other types of decorative molding and trim can be extremely difficult, tedious and frustrating to install. Precisely mitered and beveled angles are typically required where adjoining pieces of molding or trim meet at inside and outside corners of adjacent walls. Forming these angles, especially when crown molding is involved, requires that complex cuts be made in the adjoining pieces of molding typically using a compound miter saw. Wall and spring angles must be measured, bevel and miter measurements calculated and the installer's saw precisely adjusted to achieve an accurate fit, This is traditionally a tedious, time consuming and highly unreliable process. Oftentimes, the installer uses trial and error, which can result in uneven and unattractive joints in the molding. Time and expense can be wasted attempting to correct poor results and many times a desired neat and attractive appearance is never achieved.

Precalculated crown molding tables and software have been developed to assist the installer and facilitate the molding installation process. Nonetheless, using such resources remains a time consuming, tedious and often inaccurate process. The results are still apt to be unsatisfactory particularly if an inexperienced installer is involved,

Recently, protractors have been developed for measuring wall angles and spring angles, which are needed in order to derive miter and bevel angle adjustments for the installer's saw. See Boutan, U.S. Pat. No. 7,574,813. A need exists for an improved two plane molding protractor wherein the wall and spring angle adjustments can be made even more precisely, quickly, accurately, and efficiently. A particular need exists for a protractor display that intuitively and graphically conveys to the installer pertinent information regarding calculated bevel and miter angles and related saw cut adjustment and positioning required in the molding installation process.

### SUMMARY OF THE INVENTION

It is therefore an object of the present invention to provide a two plane protractor and display mechanism for quickly, conveniently and efficiently determining proper miter and bevel angles required for installing adjoining pieces of molding and trim in crown molding and related applications.

It is a further object of this invention to provide a two plane protractor that employs a much more precise and mechanically effective geared operation that enables significantly improved wall and spring angle measurements to be taken in virtually any environment requiring corner molding installation.

It is a further object of this invention to provide a two plane protractor mechanism employing wall angle measurement arms that are operably interconnected through a gear mechanism that allows the arms to adjust in unison rather than independently so that measuring wall angles may be accomplished more evenly and quickly.

It is a further object of this invention to provide a two plane protractor that likewise operably interconnects a pair of spring angle measurement arms through a gear mechanism that allows those arms to operate in unison and thus more efficiently.

It is a further object of this invention to provide a significantly improved display for a crown molding and trim protractor featuring intuitive, easy to read and understand and extremely accurate digital and graphic representations that effectively convey measured and calculated information and suggested trim positioning to the user so that cut angles are more accurately formed and the molding and trim installation is facilitated.

It is a further object of this invention to provide a protractor that allows both wall angles and spring angles to be measured much more quickly and accurately than has been previously possible.

It is a further object of this invention of a protractor and display that operates effectively in two planes or degrees of freedom and which obtains measurements simultaneously in both planes without having to perform separate measurements.

This invention features a two plane protractor and display device for use in combination with a pair of trim pieces to determine miter and bevel angles for installing adjoining pieces of molding and trim. The device includes a base and a pair of opposing wall angle measurement arms mounted to the base and pivotally interconnected to each other through operatively interengaged gears that allow the wall angle measurement arms to pivot in unison relative to one another in a first degree of freedom. A pair of spring angle measurement arms are mounted respectively to the wall angle measurement arms. Each spring angle measurement arm rotates in a second degree of freedom about a longitudinal axis of a respective wall measurement arm. The spring angle measurement arms are respectively attachable to and supportive of the trim pieces. A first sensor measures the angular displacement between the wall angle measurement arms, which yields a wall angle measurement. A second sensor measures rotational displacement of at least one spring angle measurement arm about the longitudinal axis of the wall angle measurement arm to which the spring angle measurement arm is mounted. A microprocessor calculates bevel and miter angles based upon the measured wall and spring angles. An electronic display is communicably connected to the sensors and the microprocessor for displaying the measured wall and spring angles and the calculated bevel and miter angles.

In a preferred embodiment, the gear assembly includes a pair of gear assembly support shafts mounted to the base and a pair of operatively engaged pivot transfer gears respectively supported by the gear assembly support shafts. The pivot transfer gears are respectively fixedly attached to the wall angle measurement arms for selectively rotating in opposing directions on the base to angularly adjust the wall angle measurement arms.

Each spring angle measurement arm may include teeth for biting into a respective trim piece held by the spring angle measurement arm and restricting relative movement between the trim piece and the spring angle measurement arm holding the trim piece. Each spring angle measurement arm may carry a curved guide slot that is engaged by a guide pin for guiding rotational movement of the spring angle measurement arm. Each spring angle measurement arm may be selectively gripped by a locking mechanism supported by the wall angle measurement arm to which the spring angle measurement arm is attached. This holds the spring angle measurement arm at a selected rotational tilt relative to the attached wall angle measurement arm.

The first sensor may be attached to the base and an associated one of the gear support shafts may be fixedly connected to a respective pivot transfer gear that is rotatably mounted in the base. The first sensor may be responsive to rotation of that associated gear support shaft for measuring the angular displacement of the wall angle measurement arms.

A first wall angle measurement arm may include an axially shaft for supporting a respective first said spring angle measurement arm. The first spring angle measurement arm may be fixed to the axially rotatable shaft so that the shaft axially rotates when the first spring angle measurement arm rotationally tilts. In such versions, the second sensor may be carried by a first wall angle measurement arm and be responsive to axial rotation of the shaft for measuring rotational tilt of the first spring angle measurement arm.

The gear assembly may further include a tilt angle transfer gear portion operatively interconnecting the spring angle measurement arms such that angular rotations of one of the spring angle measurement arms is transmitted to the other spring angle to angularly rotate the spring angle measurement arms in unison. The tilt angle transfer gear portion may further include a first operatively interengaged pair of tilt transfer spur gears, each supported by a respective gear support shaft and above a respective pivot transfer gear and being rotatable relative to said respective pivot transfer gear. The tilt angle transfer gear portion may further include a first pair of operatively interengaged bevel gears for transmitting rotational tilt from one of the spring angle measurement arms to one of the tilt transfer spur gears. A second pair of operatively engaged bevel gears may be provided for transmitting rotational tilt from the other of the spring angle measurement arms to the other tilt transfer spur gear. As a result, the interengaged tilt transfer spur gears rotate in opposite directions and the tilt measurement arms tilt in unison. The base may include a housing for enclosing the gear assembly.

One or both of the sensors may include capacitive sensor disks for detecting the pivotal and rotational movement of the respective angle measurement arms. Alternative sensors such as solid state, resistance, LED or light sensors may also be employed.

This invention also features a display for a two plane protractor device. In particular, the display includes a graphic depiction of a piece of trim to be cut as well as graphic icons and digital representations of the bevel and miter angle calculations and the suggested placement of a trim piece to the cut on a compound miter saw. Preferably, the digital indications of calculated miter and bevel angles are depicted simultaneously with the graphic icons simulating a trim piece to be cut and suggested placement of that piece on the compound miter saw.

In a preferred embodiment, the display may depict graphic icons selectively simulating left hand and right hand pieces of trim and simultaneously depicting calculated bevel and miter angles numerically and digitally. The display may depict graphic icons and calculated angles selectively for “bevel left” and “dual bevel” compound miter saw applications. The display may be actuated for graphically depicting suggested placement of a piece of trim to be cut on a compound miter saw. Specifically, the display may include non-numerical graphic icons representing a piece of trim and recommended placement of the trim against a fence of a compound miter saw. The display may be operated to selectively depict graphic representations of right hand and left hand pieces of trim. A calibration button may be manually engaged for at least a predetermined time for calibrating the first and second sensors. The calibration button may be momentarily toggled after the first and second sensors are calibrated to selectively alternate between bevel left and dual bevel calculations represented on the display. Buttons may be provided for holding calculated miter and bevel calculations and related graphic representations for right hand and left hand trim pieces respectively, at least while the display remains activated.

### BRIEF DESCRIPTION OF THE DRAWINGS

Other objects, features and advantages will occur from the following description of a preferred embodiment and the accompanying drawings, in which:

FIG. 1 is a top perspective view of a two plane protractor and display device in accordance with this invention;

FIG. 2 is a top perspective and cross sectionally cut away view of the protractor of FIG. 1;

FIG. 3 is a fragmentary and cross sectionally cut away view depicting the gear support shafts, gear assembly and attached wall angle measurement arms employed in the version shown in FIGS. 1 and 2;

FIG. 4 is a fragmentary, cross sectionally cut away view of one of the spring angle measurement arms employed in the protractor shown in FIGS. 1-3; the spring angle measurement arm is attached to an axial sensor shaft that is in turn operatively interconnected with a second sensor carried in a casing of the wall angle mounting arm that supports the depicted spring angle mounting arm;

FIG. 5 is a top perspective view of an alternative preferred embodiment of the protractor and display device of this invention with the display omitted for clarity;

FIG. 6 is a perspective fragmentary view of the base, wall angle measurement arms and gear assembly used in the version of FIG. 5;

FIG. 7 is a top perspective fragmentary view of the gear assembly as mounted within the base in the version of FIGS. 5 and 6;

FIG. 8 is a perspective view of a representative pivot transfer gear and integrally attached wall angle measurement arm employed in embodiment of FIGS. 5-7;

FIG. 9 is a perspective view of a representative tilt and transfer gear and integral bevel gear as featured in the protractor of FIGS. 5-7;

FIG. 10 is an elevational, cross sectional view of the gear supportive sensor shafts and gear assembly employed in the version of FIGS. 5-7;

FIG. 11 is a schematic view illustrating the electronic interconnection between the sensors, processor, display screen and actuator buttons of the display module;

FIG. 12 is a front elevational view of a preferred display module employed by the protractor and display device of this invention which depicts the functions and operations of the device;

FIG. 13 is a front elevational view of the display module wherein miter and bevel angle calculations are digitally depicted and a suggested cut is shown graphically for a right piece of trim to be cut on a dual bevel saw;

FIG. 14 depicts a slightly modified version of the display, wherein a calibration function is employed; a mode is selected which digitally indicates the measured wall and spring angles on the screen display;

FIG. 15 is a view similar to FIG. 14 of the protractor display module; the display screen is illustrated as digitally providing calculated miter and bevel angles; in addition an icon simulating a piece of trim is depicted graphically and a suggested placement of the trim on a compound miter saw and a cut according to the calculated miter and bevel angles are also represented graphically; and

FIG. 16 is a view of just the display screen shown in FIG. 15, which references each component of the simultaneous digital and graphical display.

### DETAILED DESCRIPTION OF PREFERRED EMBODIMENTS

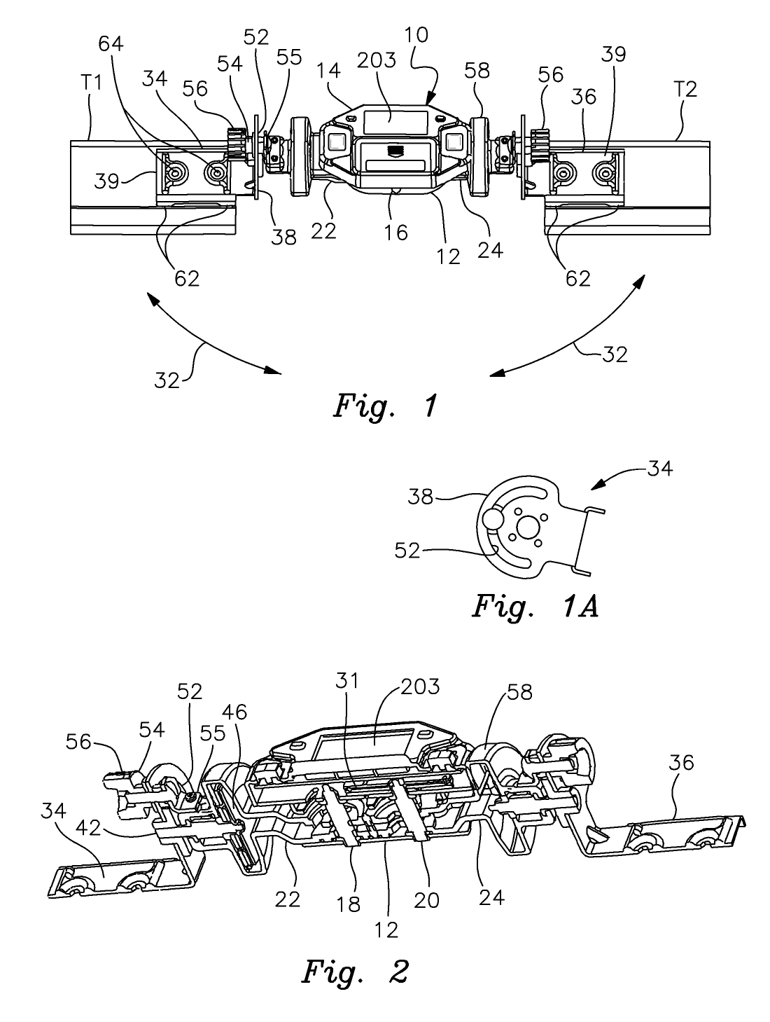

There is shown in FIG. 1 a two plane protractor and display device 10 for calculating and displaying miter and bevel angles needed to install adjoining pieces of molding and trim in crown molding and other carpentry applications. The particular environment and trim or molding application in which protractor 10 is employed are not limitations of this invention. Nonetheless, the protractor is especially useful for determining the complex saw cut angles that must be formed in adjoining pieces of molding or trim used in crown molding and analogous applications where adjoining walls meet at a corner. As used herein, the terms “trim” and “molding” should be understood as being used interchangeably. Complex angles in adjoining pieces of trim are often required when those pieces meet at an inside or outside corner of a room or otherwise where two adjoining walls meet. The present invention enables both the wall angle and the spring angle between the ceiling and the walls to be measured quickly, easily and accurately. Protractor 10 also enables the bevel and miter angles, which are required for the compound miter saw typically used to cut the adjoining pieces of trim, to be calculated and conveyed to the installer in an accurate, graphically intuitive and easy to understand fashion.

As shown in FIGS. 1 and 2, protractor 10 includes a base plate 12 and a display module 14 that is mounted to and spaced above base plate 12. The display module is interconnected to the base plate by forward and rearward standoff elements 16. Only the forward standoff element is shown in FIG. 1. Display module 14 and base plate 12 are also interconnected by a pair of generally vertically oriented pivot shafts 18 and 20, which further support the gear assembly of the protractor and can also function as part of one or more of the sensor assemblies as described below.

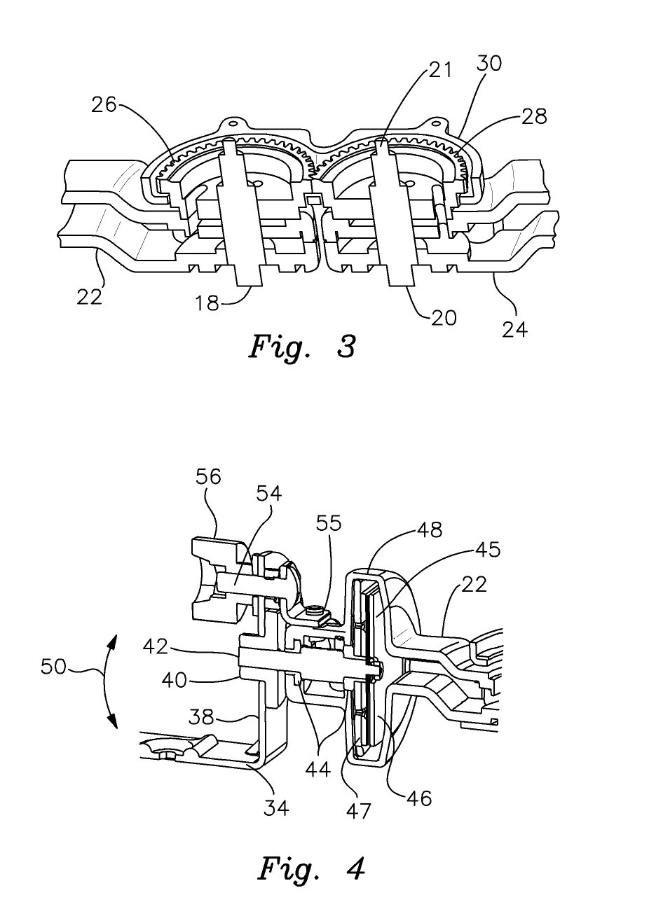

As further shown in FIGS. 1-3, an opposing pair of wall angle measurement arms 22 and 24 are pivotably mounted to base plate 12 by respective pivot shafts 18 and 20. The inner ends of arms 22 and 24 are integrally fixed to respective pivot transfer gears 26 and 28, FIG. 3, which preferably comprise spur gears or other operatively interengaged gears. The gears are enclosed in a dustproof case 30 that is depicted cross sectionally in FIG. 3. This provides for a geared interengagement between wall angle measurement arms 22 and 24 that allows those arms to be angularly adjusted in unison relative to one another in a first degree of freedom as indicated by double headed arrows 32 in FIG. 1. The wall angle measurement arms 22 and 24 are thereby able to measure interior and exterior wall angles as will be described below.

Arms 22 and 24 as well as integral gears 26 and 28 are fixedly interconnected to respective pivot shafts 18 and 20. In certain embodiments shaft 18 may be fixedly interconnected between base plate 12 and display module 14 and gear 26 may be rotatably mounted on shaft 18. In any event, both wall angle measurement arms are pivotable on the base. The upper stem 21 of pivot shaft 20 is operatively interengaged in a conventional manner with a first capacitive disk sensor 31, best shown in FIG. 2. Specifically, a first capacitive disk is fixedly attached to stem 21 and spaced apart from a cooperating second capacitive disk mounted in the display module. As the arms 22 and 24 angularly pivot relative to one another, upper stem 21 of the shaft 20 fixed to arm 22 axially rotates a corresponding angle through sensor 31 and the spaced apart sensor disks cooperate to measure the angular displacement between arms 22 and 24. This represents the wall angle measurement.

A pair of spring angle measurement arms 34 and 36 are shown in FIGS. 1, 2 and 4. Each of arms 34 and 36 comprises a generally L-shaped bracket. As best shown in FIG. 4, a vertical leg 38 of arm 34 is fixedly connected by a fitting 40 to a generally horizontally disposed tilt sensor shaft 42 mounted in the outer end of wall angle measurement arm 22. Pivot shaft 42 effectively defines a longitudinal axis of wall angle measurement arm 22. In particular, the outer end of tilt sensor shaft 42 is fixed to fitting 40 and the tilt sensor shaft rotates in bearings 44 within arm 22. An inner end of tilt sensor shaft 42 is operatively interengaged with a second capacitive disk sensor 46 mounted within a disk shaped chamber 48 of arm 22. The function of sensor 46 is described more fully below.

Shaft 40 allows spring angle measurement arm 34 to be rotated or tilted in a second degree of freedom as generally shown by double headed arrow 50. As further shown in FIGS. 1 an 2, the upper end of leg 38 includes a curved guide slot 52 (FIG. 1), which receives a threaded bolt or pin 54 that is itself fixedly attached to an L-shaped bracket 55 attached by bolts at the outer end of arm 22. Pin 54 thereby effectively serves as a guide pin, which interengages complementary guide slot 52 to permit spring angle measurement arm 34 to tilt selectively back and forth about tilt sensor shaft 40 within the limits established by slot 52 as indicated by double headed arrow 50. The complementary guide pin and guide slot constrain or limit the angularly degree to which the spring angle measurement arm can be tilted. An interiorly threaded nut or knob 56 may be selectively tightened onto pin 54 and against leg 38 of arm 34 to lock the spring angle measurement arm at a selected angle (i.e. the “spring angle”) relative to the longitudinal axis of the wall measurement arm 22.

More particularly, arm 34 is fixedly attached to tilt sensor shaft 42 so that, as arm 34 rotates relative to the longitudinal axis of arm 22, shaft 42 axially rotates within arm 22. The inner end of shaft 42 is operatively interengaged with a rotating disk 45 of a capacitive disk sensor 46, again in a manner know in the sensor art. A second, spaced apart capacitive disk 47 is mounted in chamber 48 in operative relationship with disk 45. Accordingly, rotation of the inner end of shaft 42 causes the equivalent rotation or tilt of arm 34 to be measured by sensor 46. This represents the spring angle measured by the device.

Spring angle measurement arm 36 and the wall angle measurement arm 24 to which it is attached are themselves operatively interconnected in a manner generally similar to that previously described for wall angle measurement arm 22 And spring angle measurement arm 34. Typically, the only significant difference is that a sensor is omitted from disk-shaped chamber 58 of arm 24. See FIG. 2.

As best shown in FIG. 1, spring angle measurement arms 34 and 36 are attached to respective pieces of trim or molding T1 and T2 when protractor 10 is used to measure wall and spring angles. Trim pieces T1 and T2 should include pieces that are representative of the trim or molding to be installed. Before protractor 10 is operated, two small pieces of trim T1 and T2 are cut. Preferably, each piece is approximately 5 inches long and includes square ends. As best shown in FIG. 1, the horizontal leg 39 of each spring angle measurement arm carries a plurality of points or downwardly pointing teeth 62 that are formed along both longitudinal edges of each leg 39. Teeth 62 are offset along respective parallel ribs formed along the side edges of each leg 39. These teeth allow the arms 34 and 36 to effectively bite or dig into the respective pieces of trim T1 and T2. This configuration is especially effective for securely engaging curved or otherwise non-flat outer surfaces of the trim. Holes 64 are also provided in legs 39 for receiving respective wood screws to secure the trim pieces T1 and T2 to the respective spring angle measurement arms 34 and 36. The biting teeth 62 improve the grip so that the trim pieces remain securely in place during use of the protractor. This facilitates the taking of accurate measurements.

After trim pieces T1 and T2 are secured to spring angle measurement arms 34 and 36 respectively, protractor 10 may be operated to measure the wall angle and spring angle involved in a particular crown molding installation. Locking knobs 56 are loosened and protractor 10 is engaged with the inside or outside wall corner such that trim pieces T1 and T2 fit properly against respective walls and the ceiling at the corner. The wall angle measurement arms adjust angularly in unison to reflect the wall angle being measured. The geared interengagement between the arms 22 and 24 enables the protractor to be angularly adjusted in a easy, quick and efficient manner, with the arms moving in unison rather than individually and separately. The spring angle measurement arms are also tilted so that trim pieces T1 and T2 fit properly against the ceiling and the respective walls in a manner analogous to the crown molding that will be eventually installed. When this position is achieved, knobs 56 are tightened. When the wall and spring angle measurement arms have been set in the foregoing manner, the display module of the protractor is operated to display the measured wall and spring angle measurements and to calculate required bevel and miter angles in the manner described below.

In alternative embodiments, different numbers and arrangements of wall and spring angle sensors may be employed in protractor 10 in order to achieve required levels of accuracy. For example, instead of the single wall angle sensor 31 and single spring angle sensor 46 shown in the version in FIGS. 1-4, other versions may employ the following arrangements:
two wall angle sensors (e.g. operatively engaged with pivot shafts 18 and 20 respectively) and one spring angle sensor,
two spring angle sensors (mounted in chambers 48 and 58 respectively) and a single wall angle sensor; or
two wall angle sensors and two spring angle sensors located and constructed analogously to the foregoing versions

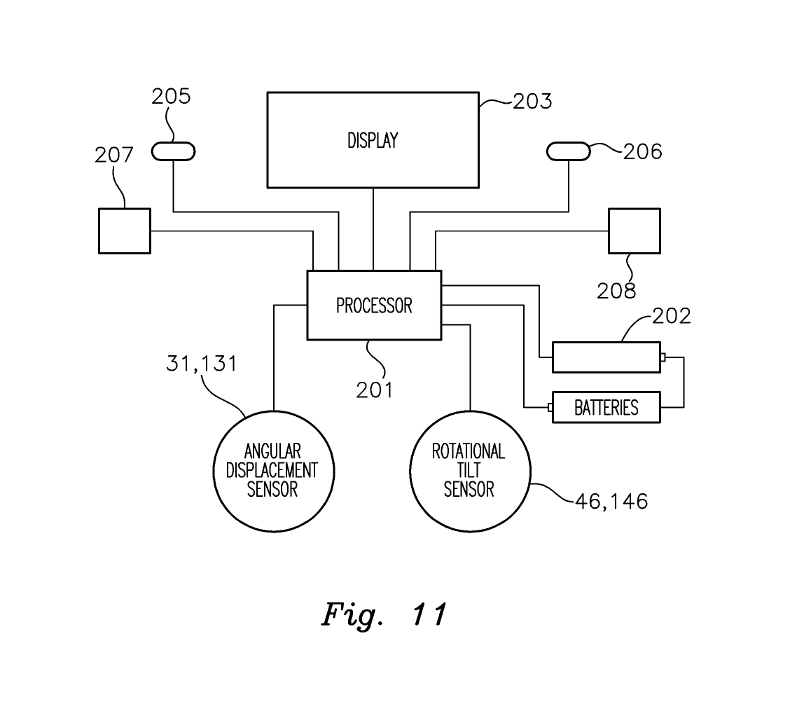

The alternative embodiment shown in FIGS. 5-10 employs a different gear assembly that allows not only the respective wall angle measurement arms but also the respective spring angle measurement arms to operate in unison. In this embodiment, the display module is omitted for clarity. However, it should be understood that the display module 14 shown in the embodiment of FIGS. 1-4 may be utilized in this alternative version as well. This structure and operation of a preferred display module, which may be used in any embodiment of this invention, is described below in connection with FIGS. 11-16.

As shown in FIGS. 5-10, protractor 110 includes a base 112 defined by upper and lower base plates 113 and 15 separated by standoffs 116. Upper and lower plates 113 and 115 are also interconnected by a pair of axially rotatable and gear supportive sensor shafts, namely a spring angle sensor shaft 118 and a wall angle sensor shaft 120. Each of shafts 118 and 120 is operatively engaged with a respective capacitive disk sensor 146 and 131, which are themselves mounted on upper plate 113 of base 112 and comprise part of the omitted display module. The sensors are electronically interconnected to the other electronic components of the display module in a manner described below.

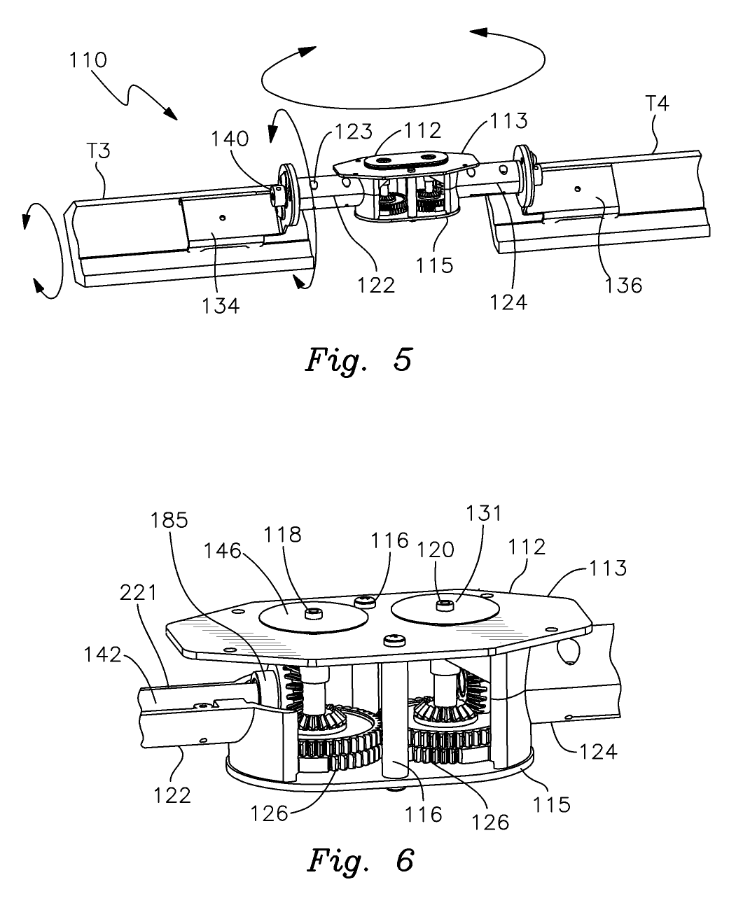

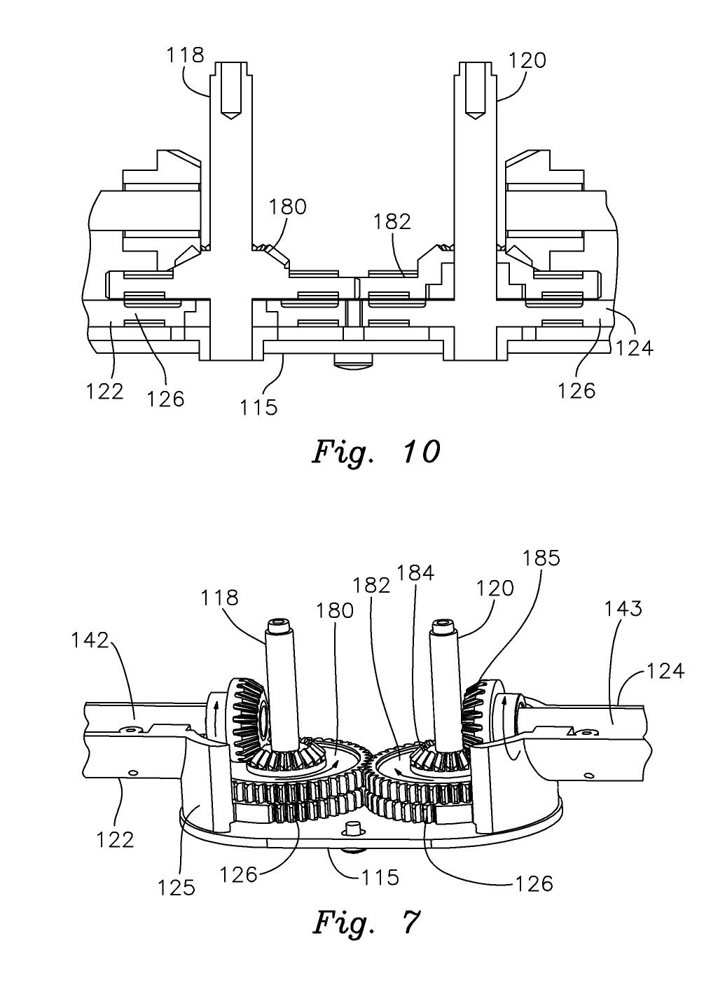

Protractor 110 again includes opposing wall angle measurement arms 122 and 124. Each such arm includes an interior channel 221, FIG. 6, for accommodating a respective tilt angle shaft 142, 143. A representative one of the arms 122, with an upper piece 123 removed to illustrate shaft 142, is depicted in FIG. 6. See also FIG. 7 wherein both arms 122 and 124 are opened to show shafts 142 and 143 respectively. The removed pieces 123 of the upper wall measurement arms are shown fully attached and the arms are fully enclosed in FIG. 5.

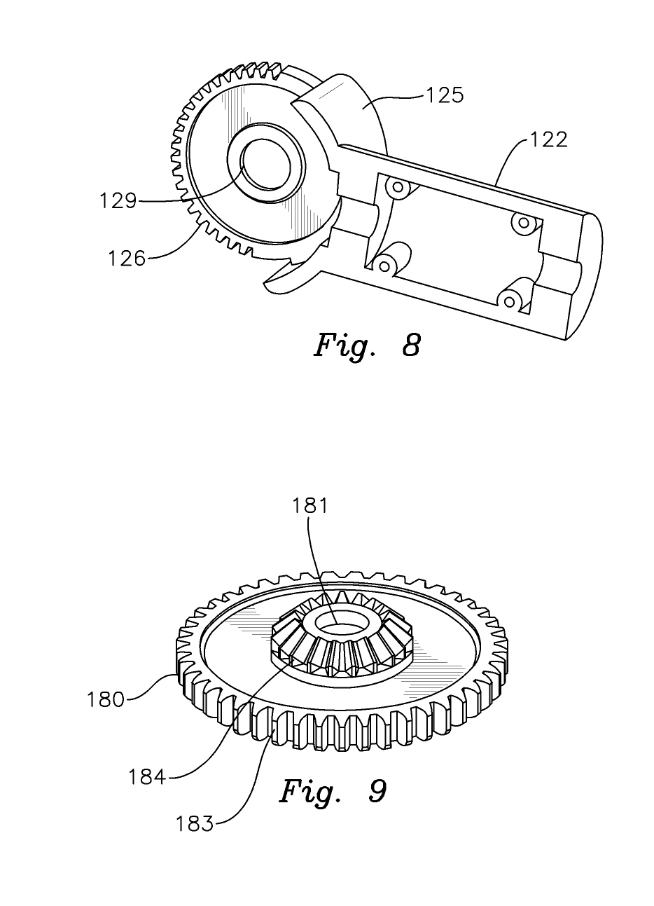

As best shown by the representative wall angle measurement arm 122 in FIG. 8, each such arm includes an inner curved segment 125 that is integrally attached and fixed to a respective pivot transfer gear 126, which preferably comprises a spur gear. Each spur gear 126 has a central opening 129 that receives a respective one of spring angle sensor shaft 118 and wall angle sensor shaft 120. As best shown in FIGS. 5-7, each arm 122, 124 is received between upper and lower plates 113 and 115 of base 112 such that the interengaged spur gears 126 and the respective curved portions 125 of arms 122 and 124 rotate or “float” within base 112 and upon the upper surface of lower base plate 115.

Wall angle measurement arms 122 and 124 respectively interengage pivot sensor shafts 118 and 120 so that the respective spur gears 126 remain operatively interengaged and the arms 122 and 124 are mounted pivotally to the base.

Spur gear 126 of wall angle measurement arm 122 is loosely or rotatably mounted to spring angle sensor shaft 118. See FIG. 10. On the other hand, the spur gear 126 of wall measurement angle 124, which is otherwise constructed analogously to arm 122, is fixedly connected to wall angle sensor shaft 120. Accordingly, pivoting either arm 122 or 124 causes wall angle sensor shaft 120 to axially rotate within base 112 whereas spur gear 126 of wall angle measurement arm 122 rotates freely about fixed spring angle sensor shaft 118. Only shaft 120 axially rotates when the wall angle measurement arms are pivotally adjusted. The rotating shaft 120 then operates the interengaged capacitive disk sensor 131 to detect wall angle measurements.

The gear assembly further includes a tilt transfer gear portion including a pair of operatively interengaged tilt transfer gears 180 and 182 that are mounted on shafts 118 and 120, respectively. A representative tilt transfer gear is depicted in FIG. 8. Each such gear includes a central opening 181 that receives one of the sensor shafts 118 and 120 Each of gears 180 and 182 includes a lower tilt transfer spur gear 183 and an upper, generally vertically oriented bevel gear 184 that is unitarily connected to spur gear 183. As best shown in FIGS. 6 and 7, each bevel gear portion 184 is interengaged with a corresponding, generally horizontally oriented bevel gear 185 that is attached at the inner end of a respective tilt angle shaft 142, 143 extending longitudinally through a respective one of wall angle measurement arms 122 and 124. Each of tilt transfer gears 180 and 182 is movably or floatably engaged with its underlying pivot transfer spur gear 126. In this way, the upper pair of interengaged tilt transfer spur gears 183 and the lower pair of operatively interengaged pivot transfer spur gears 126 operate and turn independently of one another. This allows wall and spring angle measurements to be taken independently by the protractor.

The tilt transfer gear 180 is fixedly attached to spring angle sensor shaft 118 as shown in FIG. 10. Conversely, tilt transfer gear 182 is loosely or floatably mounted about wall angle sensor 120. Accordingly, when either of the tilt transfer gears 180 or 182 is turned, only the attached spring angle sensor shaft 118 will axially rotate so that a spring angle measurement is taken in the manner described below.

As shown in FIG. 5, protractor 110 again includes spring angle measurement arms 134 and 136 that are secured by respective fittings 140 to a distal end of the respective wall angle measurement arms 122 and 124. In particular, as shown in FIGS. 6, 7, and 10, each arm 122, 124 accommodates an axially rotatable tilt shaft 142, 143. The inner end of each tilt shaft carries one of the generally horizontally aligned bevel gears 185 that engages a respective generally vertically aligned bevel gear 184 of tilt transfer gear 180. As in the previous embodiment, each spring angle arm 134, 136 includes a slotted guide that receives a fixed screw or pin for guiding and limiting the angular rotation or tilting of the respective spring arms. A tightening knob or lock may again be provided for holding the angle at which the spring arms are tilted.

The spring arms are again provided with depending points or teeth that facilitate gripping respective trim pieces T3 and T4, FIG. 5.

In operation, protractor 110, with trim pieces T3 and T4 attached, is fitted against a ceiling and adjoining walls of a corner. The wall angle measurement arms 134 and 136 are angularly adjusted in accordance with the angle between the adjoining walls. Either arm may be moved and the interengaged spur gears 126 cause both arms 122 and 124 to pivot in unison. The spur gear 126 of arm 122 floats freely about the spring angle sensor shaft 118 to which it is mounted and spur gear 126 of arm 124 rotates fixedly attached wall angle sensor shaft 120, which, in turn, operates sensor 131 to measure the wall angle.

As in the prior embodiment, the spring arms 134 and 136 are rotated relative to the wall angle measurement arms in order to fit the trim pieces T3 and T4 against the ceiling and respective adjoining walls so that a spring angle may be accurately measured. In this version, however, both spring arms tilt or rotate in unison. For example, if trim piece T3 and attached spring arm 134 are angularly tilted, this causes attached tilt shaft 142 to rotate its attached horizontal bevel 185. In turn, the interengaged vertical bevel 184 of tilt transfer gear 180 turns. This drives integrally attached spur gear 183 in a like direction. The operatively interengaged spur gear 183 of second tilt transfer gear 182 rotates in an opposite direction. See FIG. 7. This in turn rotates integral bevel gear 184, which drives interengaged bevel gear 185 at the inner end of the shaft 143 extending through wall angle measurement arm 124 in the same direction as shaft 142 extending through arm 122 was turned. As a result, the spring angle measurement arm 136 attached to wall angle measurement arm 124 and the trim piece T4 attached thereto are rotated in unison with spring arm 134 and attached trim piece T3. Spring angle measurements may then be taken. Specifically, tilt transfer gear 180 rotates fixedly interconnected spring angle sensor shaft 118 through an angle corresponding to the angle through which arms 134 and 136 tilt. Sensor 146 measures the rotation of shaft 118 and the corresponding spring angle accordingly.

In the second version of this invention, wall and spring angle measurements are facilitated because each pair of arms operates in unison. This simplifies and expedites the installer's task and makes it much easier and more convenient to measure wall and spring angles.

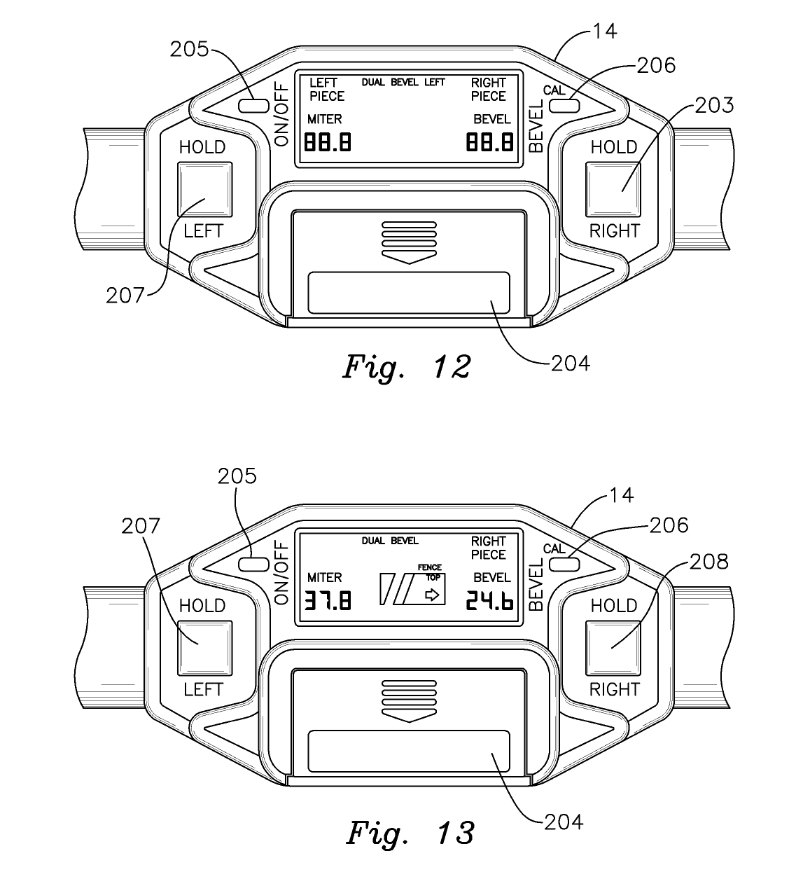

Protractors 10, 110 employ a display module featuring various electrical/electronic components to measure the wall and spring angles and calculate required miter and bevel angles to which the compound miter saw should be set. FIG. 11 illustrates a schematic of preferred electronic components employed in the protractor device. FIGS. 12-16 further depict a preferred embodiment of the display module 14 which displays the measured and calculated information both digitally and graphically so that the information required for proper cutting and installation of trim pieces is conveyed quickly, accurately, intuitively and efficiently to the installer. As previously described, wall angle displacement sensors 31, and 131, FIGS. 2 and 6, respectively, and rotational tilt sensors 46 and 146, FIGS. 4 and 6 respectively, may comprise capacitive disk sensors having a rotatable disk with a central opening engaging a threaded stem of a respective rotating sensor shaft (e.g. shafts 20, 42, 120 and 118). Typically, the capacitive sensor disk is attached securely to the stem by an appropriate nut. Rotation of the stem causes the attached disk to rotate relative to a second, stationary disk spaced apart from the rotating disk. This enables angular information to be measured and transmitted in a conventional manner to a processor. Capacitive disk sensors will be known to persons skilled in the art of electronic angle measurement instruments. The processor may comprise a microprocessor or alternative logic unit employing algorithms for calculating miter and bevel angles and programmed in a manner that will be understood by persons skilled in the art in order to perform the calculations and display functions described herein. It should be understood that various alternative sensor devices (e.g. solid state sensors, resistance, laser and light sensors may be employed within the scope of this invention. Various types of microprocessors, controllers and other forms of logic/processing units may also be utilized to process and calculate the pertinent information.

Referring to FIGS. 11-15, display module 14 includes batteries 202 accommodated by an appropriate compartment 204 within display module 14. The batteries provide power to the processor, display screen 203 and other electronic components of the display module. Display module 14 also includes display screen 203 and a plurality of manually engageable and actuatable operating buttons 205, 206, 207 and 208. Each button is operatively connected to processor 201 and actuation of that button causes the processor to perform specific assigned functions, which are then performed by the processor 201 and displayed on screen 203 as follows:

ON/OFF button 205 is pressed to activate the electronic components of protractor device 14, 114. Pressing and holding button 205 turns off the device. Each time the display module is activated by pressing ON/OFF button 205, the wall and spring angles measured by the protractor are displayed numerically and digitally as is shown in FIG. 14. Button 206, labeled BEVEL CAL is momentarily pressed to toggle between DUAL BEVEL and BEVEL LEFT functions for the particular saw involved. Button 206 may be pressed and held to calibrate the display module as is described more fully below.

HOLD LEFT button 207 and HOLD RIGHT button 208 are respectively pressed to calculate miter and bevel angles for left hand and right hand trim pieces respectively. After the protractor is set against a ceiling and pair of adjoining corner walls, as previously described, buttons 207 and 208 are selectively pressed so that processor 201 calculates the proper miter and bevel angles to which the compound miter saw should be set for left and right trim pieces respectively. For each measurement, button 206 should be pressed to set the display module to either DUAL BEVEL or BEVEL LEFT as appropriate.

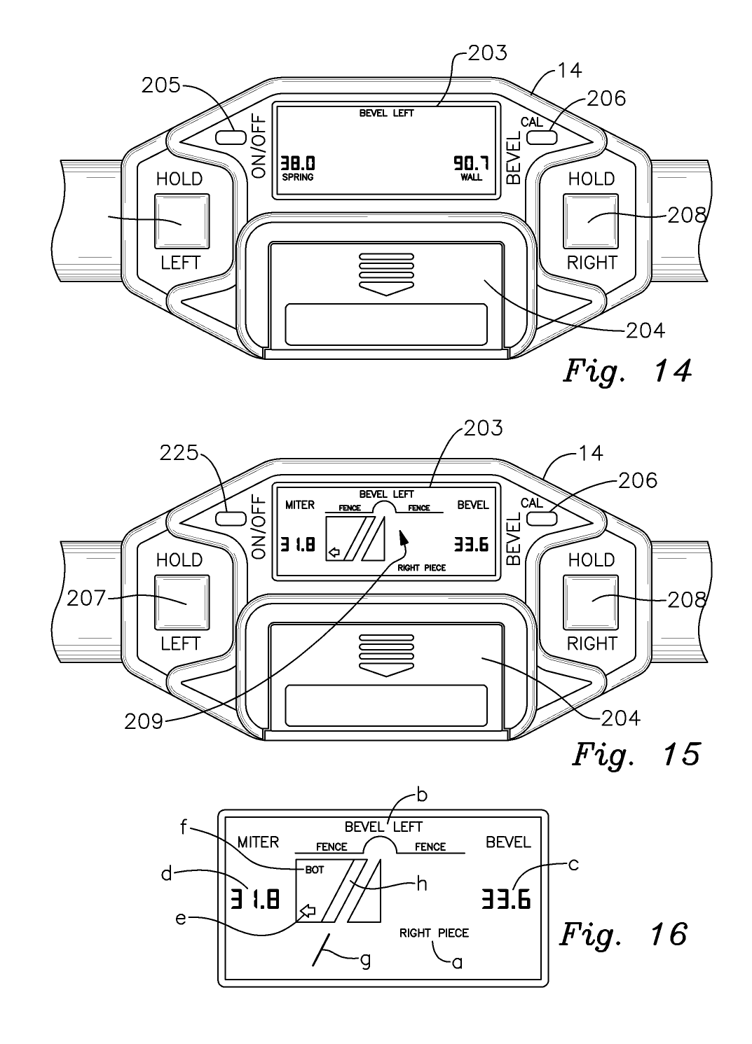

Processor 201 is also programmed to graphically represent the suggested compound miter saw cutting orientation for the specific trim piece to be cut. For example, after the protractor measurements are taken as previously described, the HOLD RIGHT button 208 may be pressed as shown in FIG. 13. This calculates the recommended miter and bevel angles (e.g. 37.8° and 24.6° respectively) to which the right piece of trim should be cut. Specifically, the saw should be set for those angles. The designation DUAL BEVEL which is set by toggling button 206, is selected if the saw being used is a dual bevel saw. Alternatively, the designation BEVEL LEFT may be selected for bevel left type saws. In any event, pressing the HOLD RIGHT button causes processor 201 to process the wall angle and spring angle settings and to derive and present a graphic illustration suggesting how to place the right piece of trim against the fence of the compound miter saw. Specifically, the graphic representation displayed on screen 203 is an icon simulating placement of the trim relative to the saw. A wide variety of icons and graphic representations may be used to graphically reflect the suggested placement. For example, a fence may be depicted as shown in FIGS. 15 and 16. A compound miter saw may be depicted as represented by the designation \textcircled{g} in FIG. 16. Various alternative icons and graphic representations may be employed within the scope of this invention.

After the miter and bevel angles are calculated and a suggested trim placement orientation is depicted, the HOLD RIGHT and HOLD LEFT buttons 208 and 207 respectively may be selected. The calculated information is retained for further use within the module until the module is subsequently deactivated. Alternatively, by pressing both buttons 207 and 208 simultaneously, the microprocessor returns the display screen to the measurement mode depicted in FIG. 14 wherein the measured wall and spring angles are displayed.

In operation, button 205 is pressed to turn on the display and enter the measuring mode. Protractor 10, 110 is then calibrated by loosening the lock knobs 56, 156, rotating the display module such that it faces upwardly and extending the wall angle measurement arms 22, 24 and 122, 124 so that the backs of trim pieces T1-T4 lie flat on a flat surface. The wall angle measurement arms should be angularly adjusted using a standard mechanical angle gauge so that they are held 90° apart. Keeping the trim pieces flat and at 90° to one another, the user presses and holds the CAL button 206 to set the values displayed on screen 203 to 90.0° spring angle and 90.0° wall angle. The screen display is in the mode shown in FIG. 14. This calibrates the protractor.

Next, the bevel function is selected. There are two types of compound miter saws. Dual bevel saws tilt both left and right. Single bevel saws tilt only to the left. Selecting DUAL BEVEL will enable the display to graphically show the cut orientation used for tilting the saw both directions. Selecting BEVEL LEFT shows the orientation used for tilting the saw only to the left. This setting can be changed any time without affecting the other settings simply by toggling button 206 to select the pertinent bevel function. The actual bevel and miter angles calculated and displayed do not change and are the same for both functional settings.

The protractor 10, 110 is then fit against the ceiling and adjoining corner walls in the manner previously described. Display module 14 is rotated so that screen 203 faces downwardly or is otherwise clearly visible to the wearer. Holding the trim pieces T1-T4 firmly and properly fit against the ceiling and adjoining walls and with the display module activated, the spring and wall angles are depicted, for example, as shown in FIG. 14. Therein, the measured wall angle is 90.7° and the determined spring angle is 38.0°. The installer then presses HOLD LEFT button 207 and/or HOLD RIGHT button 208 to calculate the respective miter and bevel angles required for proper saw cuts and installation.

FIG. 15 depicts a representative example of the graphic display that may appear when button 208 is engaged. The processor has calculated the miter and bevel angles at 31.3° and 33.6° respectively. See the numerical indications displayed digitally in FIG. 16. Display screen 203 simultaneously depicts a suggested placement of the trim against the saw. See graphic representation 209 in FIG. 15.

Representative details that may be graphically or digitally/numerically displayed on screen 203 when either of buttons 207 or 208 is engaged (in this case button 208) are shown in FIG. 16. The specific indications are as follows:
\textcircled{a} This indicates that a right piece of trim is to be cut
\textcircled{b} This designation indicates that the module has been set for a bevel left type compound miter saw, which is accomplished by toggling button 206 as needed.
\textcircled{c} This reflects the bevel angle calculated by processor 201
\textcircled{d} This reflects the miter angle calculated by the processor
\textcircled{e} This arrow indicates that the trim piece to be cut is positioned to the left of the blade
\textcircled{f} The BOT designation within the trim indicates that the bottom edge of the trim is to be held against the fence of the saw. That fence is graphically depicted and similarly labeled with the designation FENCE
\textcircled{g} This graphically represents suggested angular adjustment of the saw and indicates that it should be mitered to the left
\textcircled{h} This graphically represents the suggested bevel cut on the trim and reflects that the saw should be beveled to the left.
   It should be understood that various alternative graphic icons, representations and illustrations may be employed within the scope of this invention. After the required calculations are made and the suggested orientation and positioning of the trim pieces are displayed, the installer can effectively use the intuitively displayed information to quickly, easily and reliably set the compound miter saw and thereby quickly and accurately form the required complex angles in the adjoining pieces of trim. This enables the installer to fit the crown molding or other trim pieces neatly, evenly and precisely against the ceiling and walls so that an attractive appearance is achieved with much less difficulty and effort than has previously been required.

The protractor and display device may be constructed using various materials conventionally used in tools, gauges and instruments employed in woodworking, carpentry and similar fields. Lightweight, yet durable metals, metal alloys and plastics are especially preferred.

The present invention enables wall and spring angles to be quickly, conveniently and accurately measured and further allows the carpenter or other, even less experienced installer to form even, smooth and precise installations of trim and molding. The time and tedium associated with conventional techniques is greatly reduced and the trim installation process is facilitated considerably.

Although specific features of the invention are shown in some of the drawings and not others, this is for convenience only, as each of the features may be combined with any and all of the other features in accordance with this invention.

Other embodiments will occur to those skilled in the art and are within the following claims:

What is claimed is:

1. A two plane protractor for use in combination with a pair of trim pieces to determine miter and bevel angles for installing adjoining pieces of molding and trim, said device comprising:
a base;
a pair of wall angle measurement arms pivotably mounted to said base and interconnected to one another through a gear assembly that allows said wall angle measurement arms to be angularly adjusted in unison relative to one another in a first degree of freedom;
a pair of spring angle measurement arms attached respectively to said wall angle measurement arms for rotating in a second degree of freedom about respective longitudinal axes of said wall angle measurement arms, each spring angle measurement arm for attaching to and holding a respective trim piece;
a first sensor for measuring angular displacement between said first and second wall angle measurement arms, which represents the wall angle of two adjoining walls with which said wall angle measurement arms are respectively engaged;
a second sensor for measuring rotational tilt of one of at least one said spring angle measurement arms about said longitudinal axis of said wall angle measurement arm to which said spring angle measurement arm is attached, which measured rotational tilt represents the spring angle between a ceiling and a pair of adjoining walls with which the trim pieces held by said spring angle measurement arms are respectively engaged;
a processor for calculating bevel and miter angles based upon the sensed wall and spring angles; and
an electronic display communicating with said first and second sensors and said processor for displaying the measured wall and spring angles and calculated bevel and miter angles.

2. The device of claim 1 in which said gear assembly includes a pair of gear supportive pivot shafts mounted to said base and a pair of operatively interengaged pivot transfer gears respectively supported by said gear support shafts, said pivot transfer gears being respectively attached to said wall angle measurement arms for selectively rotating in opposing directions on said base to angularly adjust said wall angle measurement arms.

3. The device of claim 1 in which each said spring angle measurement arm includes teeth for biting into a respective trim piece held by said spring angle measurement arm and restricting relative movement between the trim piece and said spring angle measurement arm holding the trim piece, said each said spring angle measurement arm including a plurality of longitudinally oriented ribs for carrying said teeth and said teeth being offset along said ribs.

4. The device of claim 1 further including a guide for constraining rotation of each said spring angle arm relative to said attached wall angle measurement arm to which said spring angle measurement arm is attached and a releasable lock that holds said spring angle measurement arm at a selected rotational tilt relative to said attached wall angle measurement arm.

5. The device of claim 1 in which said first wall angle measurement arm includes an axial shaft for supporting a respective said spring angle measurement arm.

6. The device of claim 5 in which a first said spring angle measurement arm is fixed to said axial shaft and said shaft axially rotates when said first spring angle measurement arm rotationally tilts, said second sensor being carried by a said first wall angle measurement arm and responsive to axial rotation of said shaft for measuring rotational tilt of said first spring angle measurement arm.

7. The device of claim 2 in which said first sensor is attached to said base and an associated one of said gear supportive pivot shafts is fixedly connected to a respective said pivot transfer gear rotatably mounted in said base, said first sensor being responsive to rotation of said associated gear supportive pivot shaft for measuring the angular displacement of said wall angle measurement arms.

8. The device of claim 2 in which said gear assembly further includes a tilt angle transfer gear portion operatively interconnecting said spring angle measurement arms such that angular rotation of one of said spring angle measurement arms is transmitted to the other said spring angle measurement arm to angularly rotate said spring angle measurement arms in unison.

9. The device of claim 8 in which said tilt angle transfer gear portion includes a pair of operatively interengaged tilt angle spur gears, each supported by a respective said gear support shaft and above a respective said pivot transfer gear and being rotatable relative to said respective pivot transfer gear, said tilt angle transfer gears portion further including a first pair of operatively engaged bevel gears for transmitting rotational tilt from one of said spring angle measurement arms to one of said spur gears and a second pair of operatively interengaged bevel gears for transmitting rotational tilt from the other said spring angle measurement arm to the other said spur gear whereby the interengaged spur gears rotate in opposite directions and the spring angle measurement arms tilt in unison.

10. The device of claim 1 in which said display depicts graphic icons selectively simulating left hand and right hand pieces of trim and simultaneously depicts calculated bevel and miter angles digitally.

11. The device of claim 1 in which said display depicts graphic icons simulating “bevel left” and “dual bevel” calculations and simultaneously depicts calculated bevel and miter angles digitally.

12. The device of claim 1 in which said display is selectively actuated for graphically depicting suggested placement of a piece of trim to be cut on a saw.

13. The device of claim 1 in which said display includes non-numerical graphic icons for representing a piece of trim and suggested placement of the trim against a fence of a compound miter saw.

14. The device of claim 1 in which said display selectively depicts graphic representations of right hand and left hand pieces of trim and suggested placement of such trim on a compound miter saw and simultaneously depicts corresponding calculated miter and bevel angles digitally on said display.

15. The device of claim 1 further including a calibration button that is manually engaged for at least a predetermined time for calibrating said first and second sensors, said calibration being momentarily toggled after said first and second sensors are calibrated for selectively alternating between depiction of “bevel left” and “dual bevel” display modes on said display.

16. The device of claim 1 further including buttons that are respectively engaged for holding calculated miter and bevel calculations and related graphic representations for right hand and left hand trim pieces respectively.

17. A two plane protractor device for determining miter and bevel angles to install adjoining pieces of molding and trim, said device comprising:
a pair of wall angle measurement arms pivotally interconnected to one another and angularly adjustable in a first degree of freedom;
a pair of spring angle measurement arms attached respectively to said wall angle measurement arms for rotating in a second degree of freedom about respective longitudinal axes of said wall angle measurement arms;
a first sensor for measuring angular displacement between said first and second wall angle measurement arms, which angular displacement represents the wall angle of adjoining walls with which said wall angle measurement arms are respectively engaged;
a second sensor for measuring rotational tilt of at least one said spring angle measurement arm about said longitudinal axis of said wall angle measurement arm to which said spring angle measurement arm is attached, which measured rotational tilt represents the spring angle of a ceiling and a pair of adjoining walls with which said spring angle measurement arms are respectively engaged;
a processor for calculating bevel and miter angles based upon the sensed wall and spring angles; and
an electronic display communicating with and responsive to said processor for displaying calculated bevel and miter angles and depicting graphic icons that simulate at least one of suggested positioning of a trim piece on a compound miter saw and suggested angular adjustment of a compound miter saw.

18. The device of claim 17 in which said display further depicts calculated bevel and miter angles simultaneously with said graphic icons.

19. The device of claim 1 in which at least one of said first and second sensors includes a capacitive sensor disk.

20. A two plane protractor device for determining miter and bevel angles to install adjoining pieces of molding and trim, said device comprising:
a pair of wall angle measurement arms pivotally interconnected to one another and angularly adjustable in a first degree of freedom;
a pair of spring angle measurement arms attached respectively to said wall angle measurement arms for rotating in a second degree of freedom about respective longitudinal axes of said wall angle measurement arms;
a first sensor for measuring angular displacement between said first and second wall angle measurement arms, which angular displacement represents the wall angle of adjoining walls with which said wall angle measurement arms are respectively engaged;
a second sensor for measuring rotational tilt of at least one said spring angle measurement arm about said longitudinal axis of said wall angle measurement arm to which said spring angle measurement arm is attached, which measured rotational tilt represents the spring angle of a ceiling and a pair of adjoining walls with which said spring angle measurement arms are respectively engaged;
a processor for calculating bevel and miter angles based upon the sensed wall and spring angles; and
an electronic display communicating with said first and second sensors and said processor for displaying the measured wall and spring angles and calculated bevel and miter angles.
